(19) United States
(12) Patent Application Publication
(10) Pub. No.: US 2011/0171621 A1
(43) Pub. Date: Jul. 14, 2011

(54) System and Method for Managing and Delivering Course Content to Mobile Devices

(75) Inventors: Michael K. Sims, Dallas, TX (US); Heidi Larson, Apple Valley, MN (US); Lee Ann Enquist, Woodbury, MN (US); Roger Mesler, Chicago Ridge, IL (US); Moneesh Arora, Bridgewater, NJ (US)

(73) Assignee: West Services Inc., Eagan, MN (US)

(21) Appl. No.: 12/938,587

(22) Filed: Nov. 3, 2010

Related U.S. Application Data
(60) Provisional application No. 61/245,127, filed on Nov. 3, 2009.

(51) Int. Cl. G09B 5/00

(52) U.S. Cl. 434/322

(57) ABSTRACT

A system and method of providing an electronic course to a mobile device, comprising: capturing at least an attribute of a student for a student registration; correlating the attribute to at least a first set of course content related to that student; Providing the first set of course content related to the student; Measuring a component of the students interaction related to the first set of course content; and Delivering at least a second set of course content to the student based on the component of the students measured interaction.

### CROSS-REFERENCE TO RELATED APPLICATIONS

This application claims priority to U.S. Provisional Application 61/245,127, filed on Nov. 3, 2009, the contents of which are all incorporated herein in their entirety.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2010 Thomson Reuters Global Resources

### TECHNICAL FIELD

This invention relates generally to a system and method for providing mobile learning to remotely located students. More particularly, the present invention relates to a system and method for delivering a course to a remotely located student via a mobile device and tailoring content to that student based on demographic attributes and dynamically measured attributes.

### BACKGROUND

With the high upward usage trends in mobile devices such as net books, tablets and smart phones like the iPhone, e-learning has begun to look at adapting its course programs for these platforms. Traditionally e-learning typically includes the development of a computer delivered learning or training course that can be distributed across a network and simultaneously accessed by a number of different persons, each accessing the course through a dedicated interface. This course is generally provided with a dedicated client interface for the training course, whereby the people taking the course access the material of the course on their personal computer. This interface can be in the context of a standalone application that is executed on their personal computer or using a client/server model that can provide access to a web delivered application which is provided remotely from the personal computer on a central server, or servers.

Despite these advances, there are still constant developments in e-learning. Some of the recent moves have been to what is termed mobile learning. In such arrangements, the user taking the course accesses the course material through their mobile device such as a net book, tablet or smart phone. Using such a technology, it is possible for the user to move away from the personal computer environment and to access a course anywhere through the connectivity of their net book, tablet or smart phone.

Because connectivity to a mobile device is very dependent upon location and access to a mobile signal, many of the mobile learning applications are downloading significant portions of valuable content to the mobile devices. This in turn has caused greater risk for the course provider as mobile devices have limited ability to protect that content from theft by third parties. The content is vulnerable to loss or re-posting as much of the current smart phones content files remain unencrypted. Additionally, many mobile devices are easily compromised with the posting of hacking methodologies for popular smart phones readily available on various video posting sites.

Additionally, this downloading of content to the mobile devices has also prevented real-time tracking of the student's progress or the modification of the content presentation to the student as the student progresses through the content.

Therefore, despite the advances in the field, the industry is in need of more efficient systems and methods for providing mobile learning to remotely located students.

### SUMMARY

These enumerated problems and others are addressed in accordance with the teaching of the present invention which provides a method and system for providing a course to remotely located students. Such a system may be implemented in a variety of ways, including one or more computer programs which are storable on a computer readable medium and which include computer logic which is executable on one or more mobile devices and which enables the mobile devices to interact with a central server so as to establish a remote access to specific courses interactively available on the mobile device, the specific course governed by demographic access and skills rules that measure and provide responsive content to the appropriate level to that student.

The present invention also provides a method and system to detect if the user is present while the course is being accessed. Such detection is useful to determine if the user is actually learning or participating in the course rather than just allowing the material to be delivered with any checks on interaction of the student.

The present invention also provides testing or the gathering of metrics related to the students proficiency over the course materials at the end of the course or each segment of the course to map out the student's progress.

The present invention also provides for the presentation of additional content based on the student's proficiency in the earlier material learned as well as provides access to additional content that allows a student's focus on areas where they are deficient in content, access help via the mobile device's audio, video, chat, or telephony. The present invention also provides for the presentation use of a remote device's calendaring system, which schedules and paces the student through their leaning to help the student move through their course in a timely basis.

The present invention also provides a method of downloading meaningful learning modules that the user can work through even while not in an area that has full mobile device connectivity.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 illustrates an example operational environment for a mobile device learning system.

FIG. 2 illustrates an example of a mobile device typical for use in a mobile device learning system.

FIG. 3 illustrates an example of a course application and content present in a mobile device.

FIG. 4 illustrates an example of a mobile course registration and use process.

FIG. 5 illustrates an example of a distributed learning system.

### DETAILED DESCRIPTION OF EXEMPLARY EMBODIMENT(S)

The invention will now be described with reference to exemplary embodiments which are provided to assist in an understanding of the teaching of the invention but are not to be construed as limiting the invention in any way except as may be deemed necessary in the light of the appended claims.

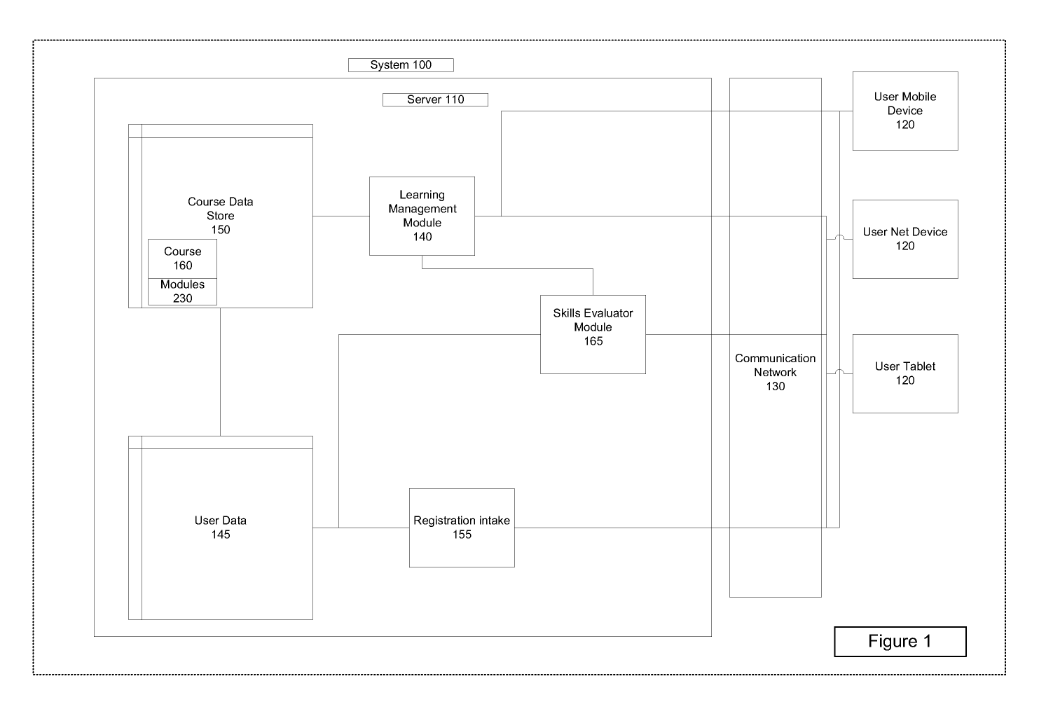

As shown in the schematic of FIG. 1, a system 100 according to the teaching of the invention includes a central server 110 which is configured to communicate with one or more remote mobile devices 120 over a communication network 130. Such a network 130 is typically a wireless network providing data transfer protocols such as GPRS or 3G. Other network types may include a wireless local area networks (WLANs) connection using IEEE 802.11 specifications or related types of wireless networks. The mobile devices 120 may include such devices as net books, tablets or smart phones such as those manufactured and provided by Google™, Sony Ericsson™, Nokia™, Samsung™, Apple™ or the like. For the sake of convenience, the invention will now be described with regard to an implementation on an iPhone™ device 120, but it will be understood that this is purely exemplary of the type of device 120 that could be used to implement the teaching of the invention.

Programming and implementation of an iPhone application using the Apple™ Software Development Toolkit are well documented and may be found at the URL http://developer.apple.com/programs/ios/ or programming books like “IPhone SDK Programming, A Beginner's Guide” James A. Brannan © 2009, the programming book is herein incorporated by reference. Conventional iPhone architecture and programming techniques for programming an iPhone device 120 are well appreciated by those skilled in the art and for the sake of clarity, extensive detail on those steps and components will be omitted from the following description unless comprising a step in the invention. Correspondingly, the server 110 desirably includes conventional computer architecture such as memory, processors, I/O devices and the like, as will be well appreciated by those skilled in the art. For the sake of clarity such conventional architecture components will be omitted from the following description.

Within the server 110 is provided a learning management module 140 which is useable to administer the delivery and tracking of a number of courses to definable mobile devices 120 related to specific students. The learning management module 140 is coupled with a course data store 150 which is configured to store specific elements of the course 160 which are available for delivery to one or more of the mobile devices 120. Also within the server 110 are provisions for registration intake module 155 and a skills evaluation module 165 which are configured to register students to the courses 160 and then to evaluate their performance on courses 160 or their modules 230. Additionally, there is a provision to cross communicate between discrete devices 120 to allow course collaboration or group learning. For the sake of clarity, courses 160 comprise multimedia content, video, audio, textual and other presentation formats. Additionally, the modules 230 may represent full lessons or groups of lessons that the user of the device may complete whether connected to the server 110 or not.

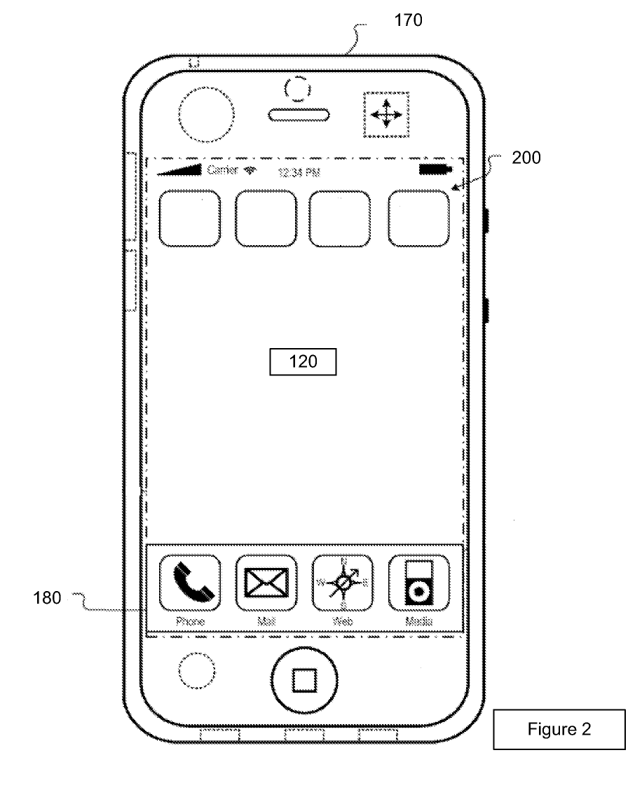

As shown in FIG. 2, a typical mobile device 120 which is useful in implementing the teaching of the invention includes a body or casing 170 which defines the exterior perimeter of the device. A graphical user interface or screen 180 is provided, typically of the dimensions three by five inches. Such screen sizes are suitable for reading extended portions of text. The invention also contemplates larger screens available to devices 120 such as tablets or net books. To enable a user to interface with the device, a touchpad 200 allowing full navigation and input is provided. Depending on the features of the specific mobile device 120, this interface 200 may also include a QWERTY keypad in the touchpad 200 or available separately, although the present invention is not to be limited to devices having such keypads.

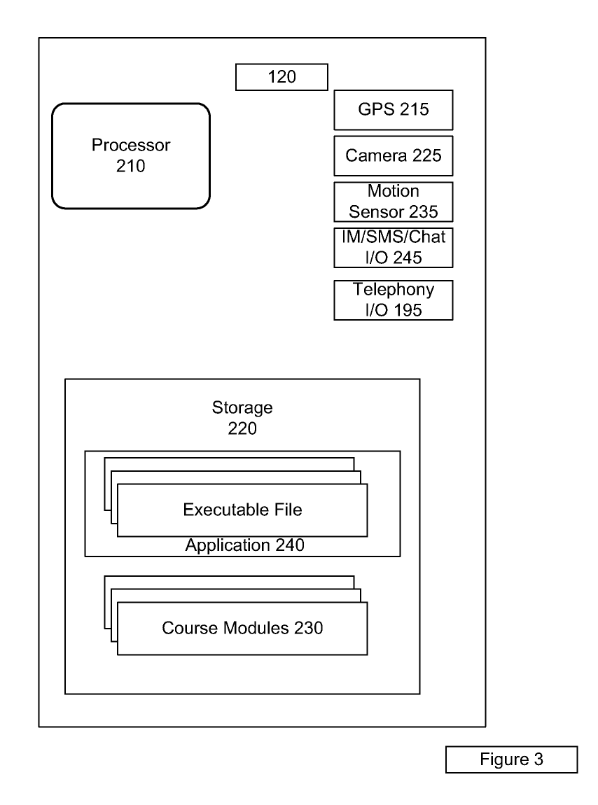

As shown in FIG. 3, within the mobile device 120, is provided a processor 210 which is used to execute computer logic and a storage module 220 on which one or more course modules 230 may be stored. Additional functions provided in the mobile device 120 may also include without limitation, a GPS module 215, a camera and/or video recorder 225, a motion sensing module 235, a IM/Chat/SMS I/O interface 245 if separate from the standard mobile device telephony I/O interface 195. The device 120 also contains applications 240 unrelated to this invention application 240, which may provide additional data for the invention application. These unrelated applications 240 comprise the mobile device 120 standard applications 240, which may also include without limitation, calendaring, timing, chat, instant messaging, video or image display, contact management, or other applications 240 that may help a student move through a course 160 remotely. In accordance with the teaching of the invention, the mobile device 120 is provided with an executable application 240 which enables the device 120 to interactively run one or more course modules 230 in contact with the learning management module 140. These modules 230 are streamed to the mobile device 120 through an I/O interface 195 of the device 120 with the server 110. In order to initially configure the device 120 for use with the present invention it is necessary to first enable an installation of the executable application 240. In the context of an iPhone device 120, the application 240 is a series of computer executable files. As the application 240 is deployed over a mobile data network 130 it is desirable that the physical size of files be kept to a minimum.

In order to effect a system providing distance learning to one or more users it possible to enable the users to individually pull the application down from a central site having at least a single server 110.

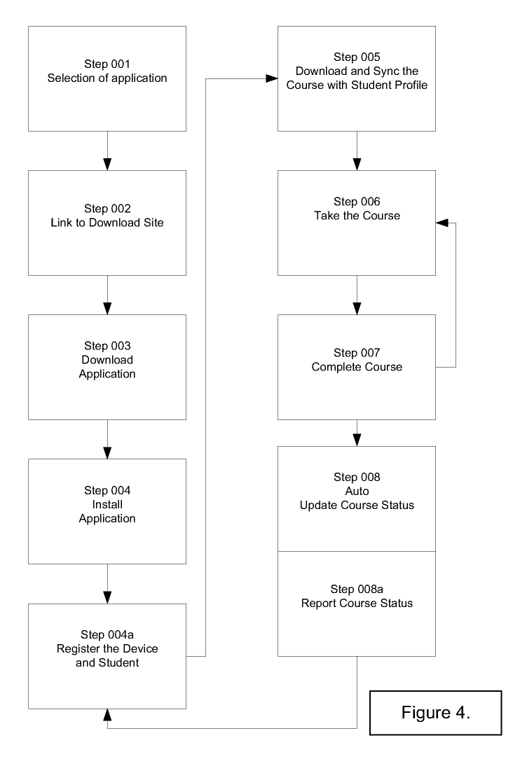

In a pull arrangement, shown in FIG. 4, the user is required to pull the application from a central server 110. In a first step of registration, the user selects the application on the central server 110 or an alternative application store if the application is vended through a commercial store like the iTunes store (Step 001). The user may then actively link to this server 110 from an email link provided to the user, or directly via a web browser provided on their mobile device 120 (Step 002). The access to the site allows a download of the application 240 (Step 003). This download may require browser filter permissions on the local mobile device 120 to be correctly set to enable the course to run correctly.

Once suitably configured with a correct installation of the local executable computer application 240, the mobile device 120 may be used to register the student via the device 120, or deliver courses 160 to the user. (Step 004) Once installed, the local application 240 is configurable to register the student and periodically access the central server 110 to allow a streaming or static download of the actual course module 230 that has been defined for distribution to the specific mobile device for a given stage in the course 160 (Step 004a). This will also allow the synchronization and customization of the course module 230 with the specific needs or profile of the device 120 user. This customization/synchronization may be made through a communication initiated by the mobile device 120 or through one initiated by the central server 110 (Step 005). In the former arrangement, the application 240 may be set to poll for course progress and download the next segment of content module 230 periodically or the user can manually interface with the server 110 to determine whether there are appropriate new course modules 230 for that user to review. Applications 240 typically are sized in the 1-3MB range and courses 160 are typically sized to be 500MB to 12 GB and may be divided into modules 230. For the larger sized courses 160, it is desirable that the courses be provided in compressed format such as a zip file and also compliant with other learning system formats as are common with online learning systems. Also the invention contemplates streaming content such that if there are courses 160 that are in excess of the memory capacity 220 of the device 120, the user or the server 110 can manage the content modules 160 into the device 120 and manage which course modules 230 that are stored resident to the mobile device 120. In most cases, once an appropriate course module 230 is loaded, the course 160 will be recursively used or updated by the system 100 to the local mobile device 120 (Step 006) as the student works through the course 160. For the sake of clarity, the device 120 may be capable of holding several courses 160 simultaneously. Additionally, to authenticate the student, the system may require sign in using standard authentication means such as a user id and password or other methods of authentication known to those skilled in the art. Also the student may be charged for the use and access of various content resources. This association of charges or use of a mobile device to a student account or credit card by methods also know to those skilled in the art.

These courses 160 are then selectable by the student user who accesses the courses 160 and their modules 230 as desired or dictated by the course 160 and then completes them as dictated by the user's skill and the requirement set for completing the course 160. (Step 007).

To ensure that the courses 160 that are provided interactively are completed satisfactorily and that the student has achieved the desired completion of the learning experience, the server 110 includes a unique set of rules for managing the user's access and learning experience. As an example, a set of access rules/skill attributes are is listed in the table below. Attributes may be embodied by logical flags, alphanumeric values or dynamically calculated values as they are required to manage access, verify payment by the student, and permit various content sets to be accessed by the student during their study of the course. Attributes can also comprises a component of measuring the level of interaction of the student, the level of the student's comprehension or the measurement of proficiency on the course subject matter, or some other aspect of allowing the student to proceed with the course. Additionally, aggregation and or weighting of these attributes may comprise a threshold score for the user's measured competency over the subject matter presented. In a low latency version of this invention, the student's presence or progress on the delivered content may be polled or checked automatically or by a response from the student. Alternatively, the student's process or progress may also be checked by testing or provision of problems or games to solve to demonstrate comprehension by the user. Use of combinations of these types of testing or participation metrics is also contemplated by this invention. In the case of a student taking a course 160 where continuous participation is a requirement, the mobile device 120 motion sensing hardware 235, may be polled by the server 110 to determine if the device 120 is in motion as would be the case if a student is holding the device 120 and interacting with the course 230. Also a tone or sound produced by the mobile device 120 may also be used as a prompt to the user to encourage or warn the user to pay attention if the device 120 remains dormant for a predetermined period (i.e. 1 minute)

| Rule Attribute | Rule Type |
|---|---|
| Student Name | Demographic |
| User Name or ID | Demographic |
| Device ID | Demographic |
| School Name or ID | Demographic |
| Current Address | Demographic |
| Telephone Number | Demographic |
| Email | Demographic |
| Year in School | Demographic/Skill |
| Course Registered | Demographic/Skill |
| Past Courses Taken | Skill |
| Current Course Progress | Skill |
| Payment Status | Demographic |
| Course Type | Demographic |
| State/Region | Demographic |
| Access to Tertiary or Additional | Skill |
| Materials | |
| Competency Threshold Score | Skill |
| Presence Online | Demographic |
| Students Participation Level | Demographic |
| Geolocation of Device | Demographic |
| Registration Number | Demographic |
| Participation Level | Skill |
| Accounts Payable Status | Demographic |
| Credit Card or Payment Information | Demographic |
| Class Rank or Collective Score | Skill |

(Step 008). This rule data is automatically managed by the central server 110 together with any feedback data gathered by the application 240 or alternatively the user or the application 240 may choose the appropriate time to upload their progress

(Step 008a). The tracking information is useful as it allows the remote administration of the mobile learning courses 160 to ensure that each of the remote parties are adequately completing their learning assignments and can also be used to effect a triggering of delivery for subsequent courses 160 or sub-elements or modules of the current course 230 for delivery to a user, once they have completed or failed at any particular learning assignments. For the sake of clarity, these rules may be used collectively, selectively or individually by the server 110 or learning management module 140 or the Skills Evaluator Module 165 to manage the access, pace, and proficiency of a particular user or set of users.

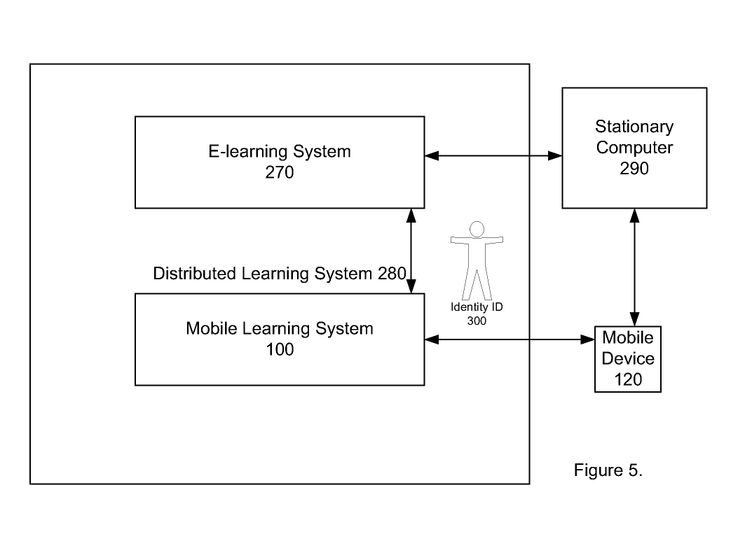

As has been described above, a system in accordance with the teaching of the invention has been described with regard to server/client architecture with the server 110 hosting the centralized audit and skills assessment function of the course being taken by multiple remote users. Such a system is advantageous in that by separating courses 160 and the software required to run the courses it is possible to provide new and personalized course on a per user basis. As shown in FIG. 5, the system of the present invention also may comprise part of a distributed learning environment 280. Operable in an asynchronous environment, the system can be scaled further by adding more servers 110, courses 160 and the like.

By providing the course in a format that is compliant with other electronic learning systems or some other similar standards, it is possible to generate courses 160 for both a traditional e-learning environment 270 where there are larger format screens, more processing power, larger bandwidth and other aspects of a stationary computer 290 are available, and then transpose aspects of that course to a mobile learning environment through use of the functionality that is present in many mobile devices 120 for use. Many of the browsers that are provided on a mobile device 120 are capable of effecting changes in the format of the viewed material to ensure that it can be viewed on a much smaller screen that what it was intended for. By providing a distributed learning environment 280, it will be understood that the level of distribution can be scaled depending on the specifics of the deployment. By associating users with an identity ID 300 and the courses 160 that they have completed it is possible to monitor both systems 270, 100 for the user's compliance with levels of learning required within a specific work environment.

It will be understood that a system in accordance with the teaching of the invention uses functionality residing on traditional mobile device 120 such as I/O peripherals, screens, browser applications etc., but also interfaces these with a standard e-learning system 270 that provides locally accessible courses 160 that are monitored and tracked by the e-learning system 270. Using the Identity ID, 300, the mobile learning system 100 synchronizes with the e-learning system 290 to give an update of the user's progress through a defined list of courses 160.

Any process descriptions or blocks in figures, such as those in the accompanying Figures, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A method of providing an electronic course to a mobile device, comprising:
Capturing at least an attribute of a student for a student registration;
Correlating the attribute to at least a first set of course content related to that student;
Providing the first set of course content related to the student;
Measuring a component of the students interaction related to the first set of course content; and
Delivering at least a second set of course content to the student based on the component of the students measured interaction.

2. The method of claim 1, where the first set of course content comprises a course related to legal study.

3. The method of claim 1, where the component of student interaction comprises calculating a threshold score related to the student's interaction.

4. The method of claim 3 where the threshold score also comprises a metric from the student completing at least a test within the first set of course content.

5. The method of claim 3 where the threshold score also comprises a metric from the student playing a testing game contained within the first set of course content.

6. The method of claim 1, where the student registration also comprises capturing at least an attribute of a previous course taken by the student.

7. The method of claim 6 where registering further comprises: capturing at least an attribute of a previous threshold score of a previous course.

8. The method of claim 1 where delivering a second set of course content also comprises addressing a measured deficiency in the student's interaction in the first set of course content.

9. The method of claim 1 where the delivering the second set of course content also: comprises requiring the student to re-take the first set of course content.

10. The method of claim 1 where the component of the measured interaction comprises sensing whether the student is actively participating in the course.

11. The method of claim 1 where the first set of course content comprises a course related to continuing education accreditation.

12. The method of claim 11 where measuring the component of the student's interaction also comprises polling the student to determine a level of participation by the student in the course content.

13. A system comprising:
at least one processor;
at least one memory or a computer-readable medium coupled to the processor and operable to store instructions, which, when executed by the processor, causes the processor to perform:
capture of at least an attribute of a student for a student registration;
correlate the attribute to at least a first set of course content related to that student;
provide the first set of course content related to the student;
measure a component of the students interaction related to the first set of course content; and
deliver at least a second set of course content to the student based on the component of the students measured interaction.

14. The system of claim 13 where the system also comprises at least a server coupled to the processor via a network.

15. The system of claim 14, where the course content comprises a course related to legal study.

16. The system of claim 14, where the component of student interaction comprises calculation of a threshold score related to the student's interaction.

17. The system of claim 14, where the threshold scores also comprises a metric from the student completion of at least a test within the first set of course content.

18. The system of claim 14, where the threshold score also comprises a metric from the students completion of a testing game contained within the first set of course content.

19. The system of claim 14, where the student registration also comprises capture of at least an attribute of a previous course taken by the student.

20. The system of claim 14 where registration further comprises: capture of at least an attribute of a previous threshold score of a previous course.

21. The system of claim 14 where delivery of a second set of course content also comprises reload of the first set of course content to address a student deficiency.

22. The system of claim 14 where the delivery of the second set of course content also: comprises requires reload of the first set of delivered course content.

23. The system of claim 14 where the measured interaction comprises detection of the student interaction with the first set of course content.

24. The system of claim 14 where the content comprises a course related to continuing education accreditation.

25. The system of claim 24 where the measure of the component of the student's interaction also comprises execution of a poll to the student to determine a level of participation by the student in the course content.

26. An article comprising a machine-readable medium storing machine-readable instructions that, when applied to the machine, cause the machine to:
Capture at least an attribute of a student for a student registration;
Correlate the attribute to at least a first set of course content related to that student;
Provide the first set of course content related to the student;
Measure a component of the students interaction related to the first set of course content; and
Deliver at least a second set of course content to the student based on the students measured interaction.

27. The article of claim 26, where the processor is coupled to at least a server via a network

28. The article of claim 26, where the course content comprises a course related to legal study.

29. The article of claim 26, where the component of student interaction comprises calculation of a threshold score related to the student's interaction.

30. The article of claim 29 where the threshold score also comprises a metric from the student completion of at least a test within the first set of course content.

31. The article of claim 29 where the threshold score also comprises a metric from the student completion of a testing game contained within the first set of course content.

32. The article of claim 26, where the student registration also comprises capture of at least an attribute of a previous course taken by the student.

33. The article of claim 32 where registration further comprises: capture of at least an attribute of a previous threshold score of a previous course.

34. The article of claim 26 where delivery of the second set of course content also comprises correction of a measured deficiency in the student's interaction in the first set of course content.

35. The article of claim 26 where the delivery of the second set of course content also: comprises requires reload of the first set of delivered course content.

36. The article of claim 26 where the measured interaction comprises detection of the student interaction with the first set of course content.

37. The article of claim 26 where the course content comprises a course related to continuing education accreditation.

38. The article of claim 37 where measurement of the component of the students interaction also comprises a poll of the student to determine a level of participation by the student in the course content.
